(19) United States
(12) Patent Application Publication
(10) Pub. No.: US 2020/0022536 A1
(43) Pub. Date: Jan. 23, 2020

(54) PORTABLE BATHING SEAT FOR BATHTUB AND SHOWER

(71) Applicant: UNITED STATES GOVERNMENT AS REPRESENTED BY THE DEPARTMENT OF VETERANS AFFAIRS, Washington, DC (US)

(72) Inventors: Pascal Malassigné, Washington, DC (US); Mark W. Cors, Washington, DC (US); Kevin Alexander, Washington, DC (US); Alexander Block, Washington, DC (US)

(21) Appl. No.: 16/496,498

(22) PCT Filed: Mar. 29, 2018
(86) PCT No.: PCT/US2018/025296

§ 371 Date: Sep. 23, 2019

Related U.S. Application Data
(60) Provisional application No. 62/480,186, filed on Mar. 31, 2017.

(51) Int. Cl. A47K 3/12; A61G 7/10

(52) U.S. Cl. CPC A47K 3/122; A61G 7/1003; A61G 7/1059; A61G 7/1038; A61G 7/1025

(57) ABSTRACT

A portable bathing seat is described. The portable bathing seat includes a platform having a top surface and a bottom surface, a first long side, a second long side, a first short side and a second short side. The platform is secured above a bathing surface by at least two legs that each have one or more feet that engage the bathing surface or an adjacent surface. The platform also includes a transfer area proximal the first short side and the transfer area is advantageously at a wheelchair transfer height. The portable bathing seat also includes a transfer pommel secured to the platform proximal the first short side and a handle secured to the platform proximal the second short side. The portable bathing seat also includes a ballast reservoir positioned below the platform and configured to hold a ballast for providing stability to the portable bathing seat.

### RELATED APPLICATION

The present application claims priority to U.S. provisional patent application No. 62/480,186 filed 31 Mar. 2017, which is incorporated herein by reference in its entirety.

### GOVERNMENT RIGHTS

The U.S. Government has a paid-up license in this invention and the right in limited circumstances to require the patent owner to license others on reasonable terms as provided for by the terms of Grant No. F0627-R awarded by The Department of Veterans Affairs.

### BACKGROUND

### Field of the Invention

The present disclosure generally relates to bathing devices and more particular relates to a portable bathing seat that can be used in the bathtub or shower.

### Related Art

Devices that assist in bathing or showering are common among the elderly and disabled patient population. The National Center for Health Statistics has reported that about 10 percent of all people over the age of 65 have difficulty bathing, and about 6 percent receive help. In an assessment of home aids, adaptations and personal assistance received after traumatic spinal cord injury (“SCI”) in a population of 2.5 million inhabitants in Denmark, the most common aids or adaptations reported were related to the bathtub or shower (69%). Despite the increased awareness for bathroom assistance, no room at home poses more threats to safety than the bathroom. The National Safety Council reports that 7.8% of all injury episodes in the bathroom involved persons of age 65 or older. This is because the greatest danger in the bathroom is slipping and falling when entering and exiting the bathtub or shower.

To meet the needs of the aging population, the home health care services industry has grown from 40.8 million dollars in 2005 to 57.2 million dollars in 2009. Similar growth is predicted into the future based on the growing number of aging individuals entering retirement and desiring to stay within their homes. During this same period, the accessible bathtub and shower industry grew from 119.1 million dollars in 2005 to 148.5 million dollars in 2010. A similar growth rate was seen in the bath and pool lift industry that grew from 36.6 million dollars in 2005 to 45.6 million dollars in 2010. This growth rate of 4.5% per year is projected to continue as the boomers retire.

Individuals with spinal cord injury/dysfunction confront equivalent or even more significant challenges in the bathroom. There are approximately 12,000 new cases of spinal cord injury each year. Of these injuries, 52% have tetraplegia and 45% have paraplegia (National Spinal Cord Injury Statistics Center). This level of injury leads to diminished abilities and, in some cases, individuals will require caregiver assistance for bathing and other activities of daily life. The National Spinal Cord Injury Statistics Center (“NSCISC”) in Birmingham, Ala., tracks over 91% of this population as living in private residences. The need to remain in the home is as compelling for a spinal cord injured patient as it is for the aging because remaining in the home prolongs independence, reduces health care costs and maintains a high quality of life.

Therefore, what is needed is a system and method that overcomes these significant problems found in the conventional systems as described above.

### SUMMARY

The present disclosure describes a portable bathing seat for use with a conventional bathtub or shower. The portable bathing seat can be used equally with a right hand or a left hand bathtub. The portable bathing seat is configured for use by non-ambulatory individuals that cannot or prefer not to sit at the bottom of a bathtub. One particular benefit of portable bathing seat is for individuals with spinal cord injury (“SCI”) or other mobility dysfunctions who cannot transfer from their wheelchair to the bottom of a bathtub. The portable bathing seat is configured to rest on two or more feet where at least a first foot is inside the bathtub and at least a second foot is outside the bathtub such that the portable bathing seat straddles the rim of the bathtub. The portable bathing seat may also be positioned on the bathing surface of a shower facility.

The present disclosure describes a novel portable bathing seat that can be placed over a right-hand bathtub in a first embodiment or placed over a left-hand bathtub in a second embodiment and is designed for use by non-ambulatory individuals and/or individuals with SCI or other disabilities who have difficulty transferring or cannot transfer to the bottom of a standard bathtub or have difficulty standing or cannot stand in the shower during bathing periods. The portable bathing seat rests on two or more feet where at least a first foot is inside the bathtub and at least a second foot is outside the bathtub such that the portable bathing seat straddles the rim of the bathtub. Alternatively, the portable bathing seat may be placed on the floor surface of a shower stall. Whether in the bathtub or the shower, the portable bathing seat assists in the bathing of individuals within a home or other facility. The portable bathing seat contains several features that assist users in transferring safely from a standing position or from a wheelchair onto the portable bathing seat. These features include a transfer surface at a height similar to wheelchair height, an angled transfer pommel to facilitate transfer from a wheelchair onto the portable bathing seat, height adjustable legs, and a ballast reservoir for stability. Additional features are incorporated into the functionality of the portable bathing seat that facilitate an easy bathing process, including: a contoured and angled backrest with a drainage trough, a seat cushion with drainage cutout corresponding to a drainage depression in the surface of the portable bathing seat, and structural kiss-offs in the ballast reservoir for added stability.

Certain advantages of the portable bathing seat include that it is configured for ambulatory access or wheelchair level transfer, configured in alternative embodiments to be placed over a right hand or a left hand bathtub, configured to fit a variety of standard bathtub widths and shower stall widths, configured with a contoured backrest, and configured to drain fluids onto the floor surface of the bathtub or shower.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts.

FIG. 1A is a perspective view diagram illustrating an example portable bathing seat positioned in a bathtub according to an embodiment of the invention.

FIG. 1B is a perspective view diagram illustrating an example portable bathing seat positioned in a shower according to an embodiment of the invention.

FIG. 2 is a perspective view diagram illustrating an example adjustable leg of a portable bathing seat according to an embodiment of the invention;

FIG. 3 is a perspective view diagram illustrating an example portable bathing seat being placed into a bathtub according to an embodiment of the invention.

FIG. 4 is a perspective view diagram illustrating an example ballast reservoir of a portable bathing seat according to an embodiment of the invention.

FIG. 5 is a bottom view diagram illustrating an example ballast reservoir of a portable bathing seat according to an embodiment of the invention.

FIG. 6 is a perspective view diagram illustrating portable bathing seat according to an embodiment of the invention.

FIG. 7 is a perspective view diagram illustrating an example portion of a transfer area of a portable bathing seat according to an embodiment of the invention.

FIG. 8 is a perspective view diagram illustrating an example transfer pommel and an example angled handle of a portable bathing seat according to an embodiment of the invention.

FIG. 9 is a perspective view diagram illustrating an example transfer area and transfer pommel of a portable bathing seat straddling a bathtub according to an embodiment of the invention.

FIG. 10 is a perspective view diagrams illustrating an example angled handle of a portable bathing seat according to an embodiment of the invention.

FIGS. 11A-11D are perspective view diagrams illustrating an example bather transferring from a wheelchair onto the portable bathing seat according to an embodiment of the invention.

### REFERENCE NUMERALS

10 portable bathing seat

20 platform

22 first short side (outer)

23 top side

24 second short side

26 first long side (back)

27 bottom side

28 second long side

30 leg

35 foot

37 cross-member

40 bathing surface

50 cushion

60 backrest

65 vertical trough

67 through hole

70 outer edge of tub

80 floor

100 transfer pommel

102 first end

104 middle section

106 second end

110 handle

112 first end

114 middle section

116 second end

120 transfer area

130 depression

140 recess

150 ballast reservoir

151 ballast reservoir fill hole

152 ballast reservoir fill hole plug

153 ballast reservoir drain hole

155 ballast reservoir drain hole plug

157 ballast reservoir kiss-off

160 ballast reservoir housing

170 leg fastener

180 leg adjustment mechanism

182 leg adjustment hole

184 leg adjustment spring pin

200 bather

210 wheelchair

### DETAILED DESCRIPTION

Certain embodiments disclosed herein provide for a portable bathing seat configured to be placed over the rim of a conventional bathtub or placed on the floor surface of a conventional shower stall. The portable bathing seat facilitates reduced injury access to existing bathing facilities and provides simplified transfer from a wheelchair to use the bathing facilities. For example, one embodiment disclosed herein includes a portable bathing seat that rests on two or more feet where at least a first foot is inside the bathtub and at least a second foot is outside the bathtub such that the portable bathing seat straddles the rim of the bathtub. Alternatively, the feet of the portable bathing seat may be placed on the floor surface of a shower stall. Whether in the bathtub or the shower, the portable bathing seat assists in the bathing of individuals within a home or other facility. The portable bathing seat allows the bather to take advantage of existing bathing facilities such as plumbing for bathing water and drainage. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

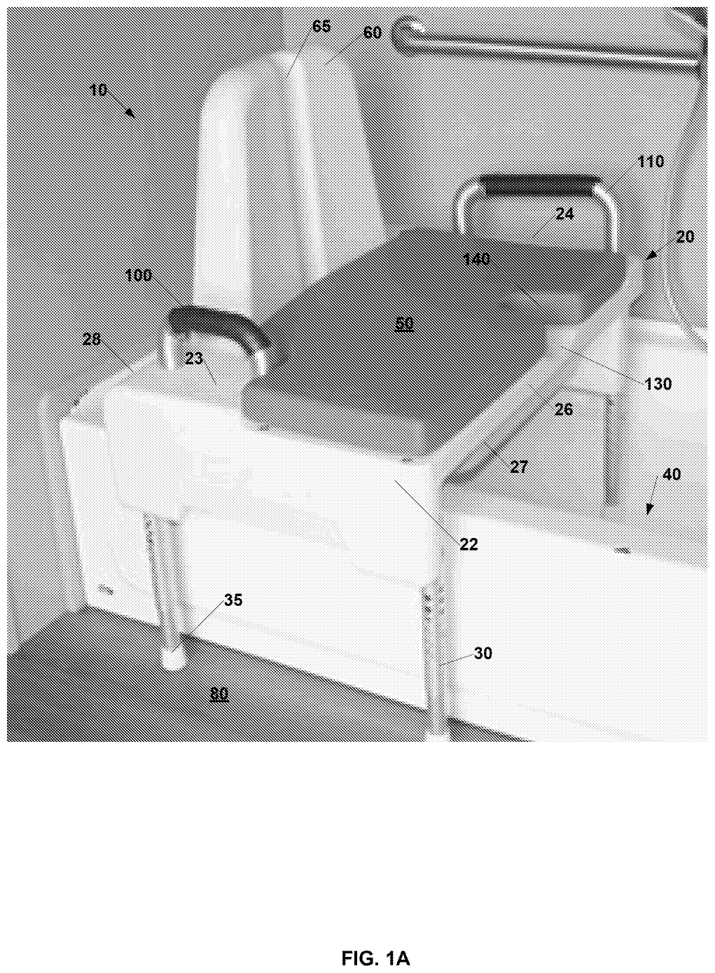

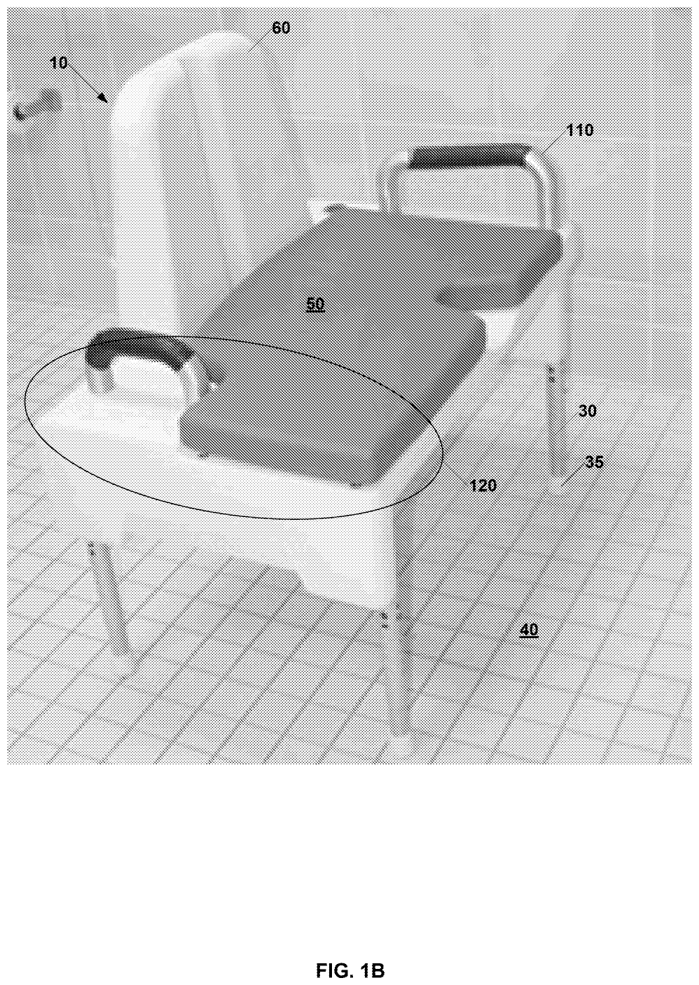

Referring generally to FIG. 1A-FIG. 10 of the drawings, various views of various embodiments of a portable bathing seat 10 are provided. In the illustrated embodiments, the portable bathing seat 10 comprises a platform 20 having a top surface 23 and a bottom surface 27, a first long side 26, a second long side 28, a first short side 22 and a second short side 24. The portable bathing seat 10 also comprises at least two legs 30, each having one or more feet 35, wherein at least a portion of the one or more feet 35 are configured to engage a bathing surface 40 and the at least two legs 30 further engage the platform 20 to secure the platform 20 above the bathing surface 40.

Additionally, the platform 20 comprises a transfer area 120 proximal the first short side 22, wherein the legs 30 secure a surface of the transfer area 120 above the bathing surface 40 at a wheelchair transfer height. The portable bathing seat 10 also includes a transfer pommel 100 secured to the platform 20 proximal the first short side 22 and a handle 110 secured to the platform 20 proximal the second short side 24. The portable bathing seat 10 additionally includes a ballast reservoir housing 160 that defines a ballast reservoir 150. The ballast reservoir housing 160 is secured to the bathing seat 10 below the platform 20. Advantageously, the reservoir is configured to hold a ballast for providing stability to the portable bathing seat 10. The ballast may be a liquid such as water or a solid such as sand or some combination of a liquid and a solid. A ballast reservoir fill hole 151 provides access to the ballast reservoir 150 so that the ballast may be introduced into the ballast reservoir 150. A ballast reservoir fill hole plug 152 seals the ballast reservoir fill hole 151 so that the ballast is not compromised by bathing fluids.

The portable bathing seat 10 may additionally include a cushion 50 that is positioned on the top surface 23 of the platform 20. The cushion may be removably attached or permanently affixed to the top surface 23 of the platform 20. Additionally, the portable bathing seat 10 may include a backrest 60 that extends upward from the first long side 26 of the platform 20. In one embodiment, the backrest 60 extends upward from the first long side 26 of the platform 20 at an angle greater than 90 degrees with respect to the top surface 23 of the platform 20. Additionally, the backrest 60 may include one or more vertical troughs 65 that are configured to channel fluid away from a bather and toward the top surface 23 of the platform 20. Moreover, the platform 20 may also include one or more through holes 67 proximal the one or more vertical troughs 65. Advantageously, a through hole 67 extends through the platform 20 from the top surface 23 to the bottom surface 27 such fluid may drain from the top surface 23 of the platform 20 down to the bathing surface 40 below.

In one embodiment, the transfer area 120 extends beyond an outer edge 70 of a bathtub that forms the bathing surface 40 when the portable bathing seat 10 is positioned with one or more feet 35 on the bathing surface 40 of the bathtub and one or more feet 35 on a floor surface 80 that is adjacent the bathtub. Advantageously, the transfer area 120 includes the transfer pommel 100 and at least a portion of the transfer pommel 100 is positioned beyond the outer edge 70 of the bathtub when the portable bathing seat 10 is positioned with one or more feet 30 on the bathing surface 40 of the bathtub and one or more feet 30 on a floor surface 80 that is adjacent the bathtub.

In one embodiment, the transfer pommel 100 is formed in a generally U shape and the transfer pommel 100 has a first end 102, a middle section 104 and a second end 106. In one embodiment, the middle section 104 is parallel to the top surface 23 of the platform 20 when the transfer pommel 100 is secured to the platform 20. In one embodiment, the transfer pommel 100 may be secured to the platform 20 by a first fastener mechanism that extends through the platform 20 from the bottom surface 27 and engages a second fastener mechanism at the first end 102 of the transfer pommel 100. Similarly, a third fastener mechanism may extend through the platform 20 from the bottom surface 27 and engage a fourth fastener mechanism at the second end 106 of the transfer pommel 100.

Also, in one embodiment the handle 110 may be formed in a generally U shape having a first end 112 and a second end 116 and a middle section 114, where the middle section 114 is positioned at an angle with respect to the top surface 23 of the platform 20 when the handle 110 is secured to the platform 20. In one embodiment, the angle of the middle section 114 of the handle 110 may range from 5% to 10% to facilitate an easier grasp of the handle by a bather. In one embodiment, the handle 110 may be secured to the platform 20 by a first fastener mechanism that extends through the platform 20 from the bottom surface 27 and engages a second fastener mechanism at the first end 112 of the handle 110. Similarly, a third fastener mechanism may extend through the platform 20 from the bottom surface 27 and engage a fourth fastener mechanism at the second end 116 of the handle 110.

In one embodiment, the legs 30 of the portable bathing seat 10 are configured to be secured to the platform 20. The legs 30 may be secured by way of friction or fastener. For example, the platform 20 may comprise one or more recesses into which a leg 30 snugly fits and is secured in place by friction. Alternatively, the platform may comprise one or more fastener holes into which a leg fastener 170 may be secured. Advantageously, a single leg 30 may have plural companion fastener holes that match up to the one or more fastener holes of the platform 20 such that plural leg fasteners 170 may be employed to secure each leg 30 to the platform 20.

In one embodiment, the legs 30 of the portable bathing seat 10 of are configured to extend and contract in length using a leg adjustment mechanism 180. For example, each leg 30 may comprise at least two parts, where a first part is configured with one or more spring pins 184 that are configured to engage one or more through holes 182 on a second part such that the first part is configured to slide into the second part and change the overall length of the leg by engaging the one or more spring pins 184 with the one or more through holes 182. In this example, the combination of the spring pin 184 and the through hole 182 is a leg adjustment mechanism 180. In one embodiment, the legs 30 may be constructed out of aluminum. In one embodiment, one or more of the legs 30 may optionally be further supported by a cross-member 37. For example, a single leg 30 may be generally U shaped with two feet 35 at each end and a cross-member 37 may extend between two portions of the U shaped leg 30 to provide additional support.

In one embodiment, the cushion 50 of the portable bathing seat 10 is made of a foam material. Additionally, the cushion 50 may include one or more recesses 140 that are positioned over one or more corresponding depressions 130 in the top surface of the platform 20. Advantageously, the combination of the recess 140 and the depression 130 is configured to allow fluid to drain away from an upper surface of the cushion 50 and away from the top surface 23 of the platform 20 toward the bathing surface 40. Advantageously, the portable bathing seat 10 may include at least a first depression 130 and recess 140 along a central portion of the second long side 28 to aid the bather in cleaning the bather's genital area.

As previously, discussed, the ballast reservoir housing 160 is positioned below the bottom surface 27 of the platform 20. The ballast reservoir housing 160 defines an interior space within which the ballast is stored. This interior space is referred to as the ballast reservoir 150. In one embodiment, the ballast reservoir housing 160 may be fastened to the platform 20. In an alternative embodiment, the platform 20 and the ballast reservoir housing 160 may comprise a single structure. For example, the platform 20 and the ballast reservoir housing 160 may be formed from a single piece of molded plastic. Advantageously, the ballast reservoir housing 160 may comprise one or more kiss-off 157 structures that extend from an exterior surface of the ballast reservoir housing 160 into the ballast reservoir 150. Additionally, the ballast reservoir housing 160 may include one or more drain holes 153 and corresponding drain hole plugs 155 to allow ingress and egress of the ballast to and from the ballast reservoir 150. Advantageously, the one or more drain holes 153 may extend through an upper or lower or side surface of the ballast reservoir housing 160.

FIG. 1A is a perspective view diagram illustrating an example portable bathing seat 10 positioned in a bathtub according to an embodiment of the invention. In the illustrated embodiment, two legs 30 are positioned with their respective feet 35 on the bathing surface 40 of the bathtub and two legs 30 are positioned with their respective feet 35 on the non-bathing surface floor 80 adjacent to the bathtub. This positions the portable bathing seat 10 to straddle the lip of the bathtub such that the transfer area 120 and the transfer pommel 100 are presented to a bather 200 that approaches the bathtub in a wheelchair or on foot.

FIG. 1B is a perspective view diagram illustrating an example portable bathing seat 10 positioned in a shower according to an embodiment of the invention. In this embodiment, all four feet 35 of the portable bathing seat 10 are positioned on the bathing surface 40.

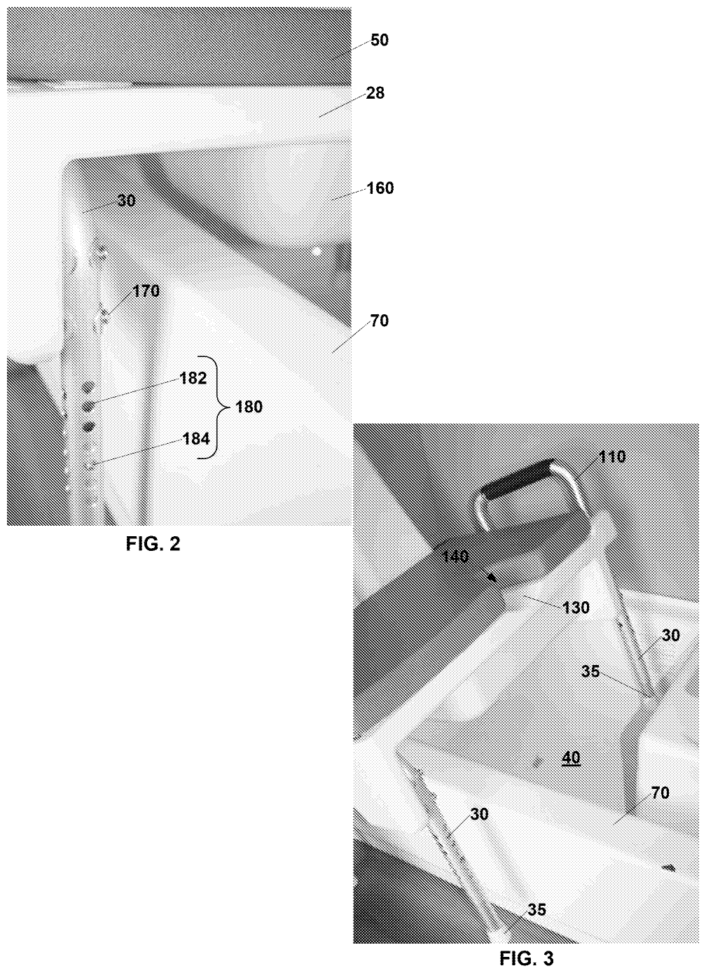

FIG. 2 is a perspective view diagram illustrating an example adjustable leg 30 of a portable bathing seat 10 according to an embodiment of the invention. In the illustrated embodiment, the leg 30 is configured to extend and contract in length using a leg adjustment mechanism 180. In the illustrated embodiment, the leg 30 comprises a first part configured with one or more spring pins 184 that are configured to engage one or more through holes 182 on a second part such that the first part is configured to slide into the second part a variable distance to change the overall length of the leg 30 by engaging the one or more spring pins 184 with the one or more through holes 182. In the illustrated embodiment, the combination of the spring pin 184 and the through hole 182 comprises the leg adjustment mechanism 180.

FIG. 3 is a perspective view diagram illustrating an example portable bathing seat 10 being placed into a bathtub according to an embodiment of the invention. Two of the four feet 35 are being positioned on the bathing surface 40 of the bathtub and two of the four feet 35 are being positioned on the non-bathing surface floor 80 adjacent to the bathtub.

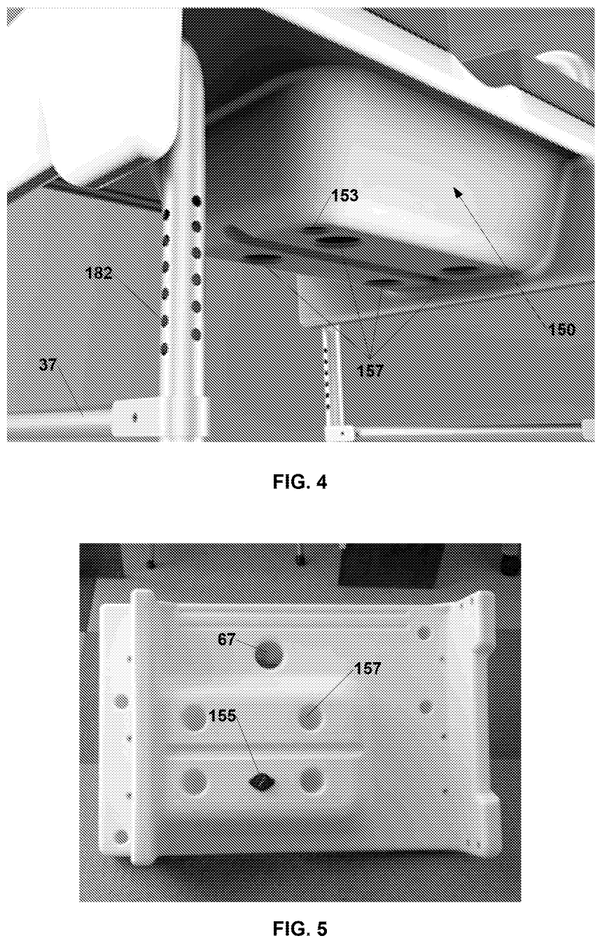

FIG. 4 is a perspective view diagram illustrating an example ballast reservoir 150 of a portable bathing seat 10 according to an embodiment of the invention. In the illustrated embodiment, the ballast reservoir 150 comprises a ballast reservoir housing 160 that is positioned below the bottom surface 27 of the platform 20. The ballast reservoir housing 160 defines an interior space within which ballast is stored and referred to as the ballast reservoir 150. In the illustrated embodiment, the ballast reservoir housing 160 includes a plurality of kiss-off 157 structures that extend from an exterior surface of the ballast reservoir housing 160 into the ballast reservoir 150. Additionally, the ballast reservoir housing 160 may include one or more drain holes 153 and corresponding drain hole plugs 155 to allow ingress and/or egress of the ballast to and from the ballast reservoir 150. Advantageously, the one or more drain holes 153 may extend through an upper or lower or side surface of the ballast reservoir housing 160.

FIG. 5 is a bottom view diagram illustrating an example ballast reservoir 150 of a portable bathing seat 10 according to an embodiment of the invention. In the illustrated embodiment, the ballast reservoir housing 160 includes a plurality of kiss-off 157 structures that add structural integrity to the portable bathing seat 10. Also in the illustrated embodiment, the drain hole plug 155 is positioned in the drain hole 153.

FIG. 6 is a perspective view diagram illustrating portable bathing seat 10 according to an embodiment of the invention. In the illustrated embodiment, two of the four feet 35 are positioned on the bathing surface 40 of the bathtub and two of the four feet 35 are positioned on the non-bathing surface floor 80 adjacent to the bathtub. Additionally, a ballast reservoir fill hole 151 and corresponding ballast reservoir fill hole plug 152 are positioned in the top surface 23 of the platform 20.

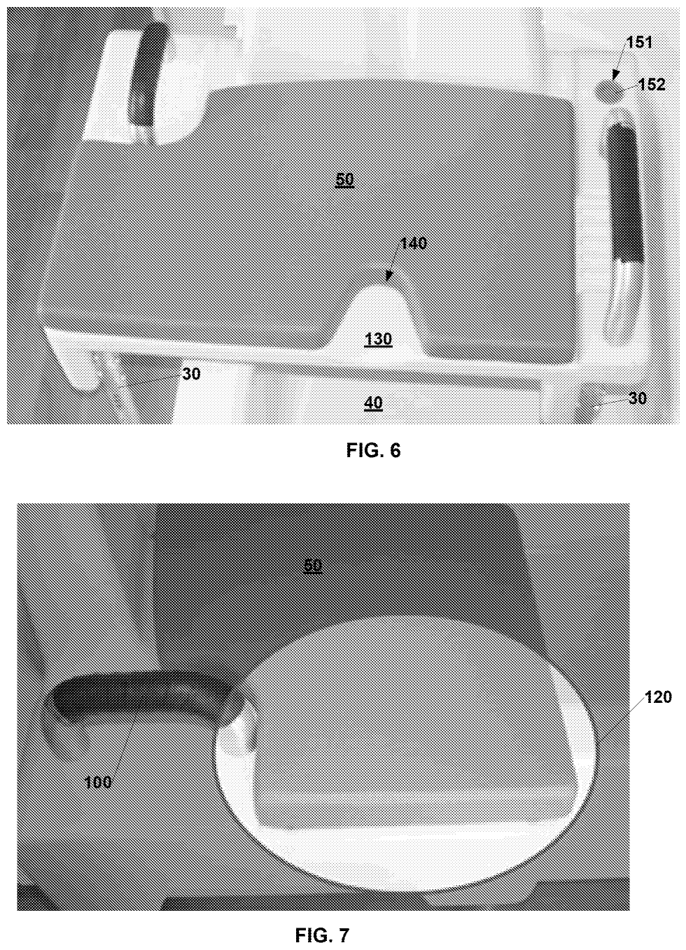

FIG. 7 is a perspective view diagram illustrating an example portion of a transfer area 120 of a portable bathing seat 10 according to an embodiment of the invention. In the illustrated embodiment, the transfer area 120 includes a portion of the cushion 50 that is positioned on the surface of the platform 20. In the illustrated embodiment, the transfer pommel 100 of the transfer area 120 is positioned adjacent to the portion of the cushion 50 of the surface of the platform 20 that is in the transfer area 120. This positioning advantageously allows a bather 200 to approach the portable bathing seat 10 and transfer onto the cushion 50 of the surface of the platform 20 while grasping the transfer pommel 100 for support.

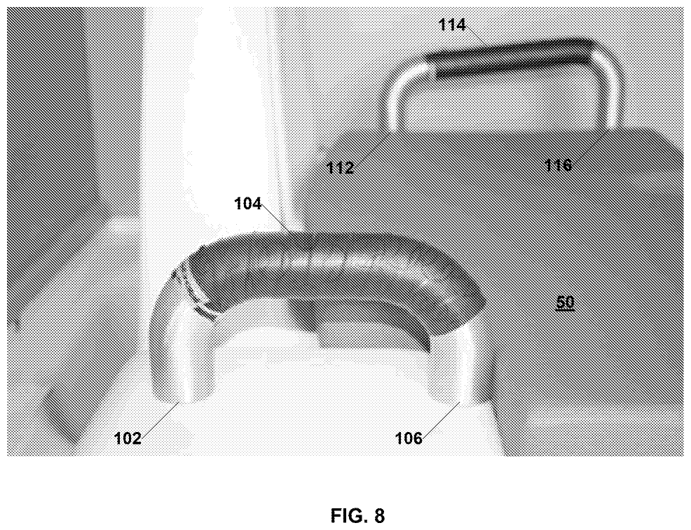

FIG. 8 is a perspective view diagram illustrating an example transfer pommel 100 and an example angled handle 110 of a portable bathing seat according to an embodiment of the invention. In the illustrated embodiment, the transfer pommel 100 is formed in an upside down U shape and has a first end 102, a middle section 104 and a second end 106. In the illustrated embodiment, the transfer pommel 100 is secured to the platform 20 by a first fastener mechanism that extends through the platform 20 from the bottom surface 27 and engages a second fastener mechanism at the first end 102 of the transfer pommel 100. Similarly, a third fastener mechanism extends through the platform 20 from the bottom surface 27 and engages a fourth fastener mechanism at the second end 106 of the transfer pommel 100.

Also, in the illustrated embodiment the handle 110 is formed in a generally upside down U shape and has a first end 112 and a second end 116 and an angled middle section 114. The angle of the middle section 114 of the handle 110 may range from 5% to 10%. In the illustrated embodiment, the handle 110 is secured to the platform 20 by a first fastener mechanism that extends through the platform 20 from the bottom surface 27 and engages a second fastener mechanism at the first end 112 of the handle 110. Similarly, a third fastener mechanism extends through the platform 20 from the bottom surface 27 and engages a fourth fastener mechanism at the second end 116 of the handle 110.

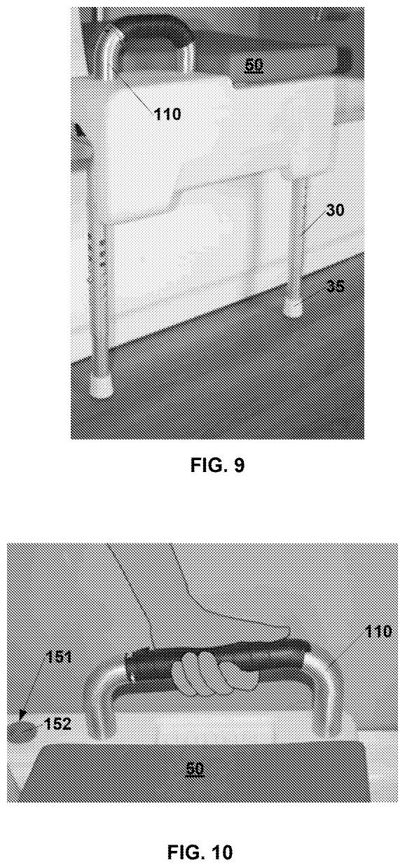

FIG. 9 is a perspective view diagram illustrating an example transfer area 120 and transfer pommel 100 of a portable bathing seat 10 straddling a bathtub according to an embodiment of the invention. In the illustrated embodiment, the transfer area 120 is positioned over the lip of the bathtub so that when a bather 200 approaches the bathtub, the transfer area 120 is presented to the bather 200 and the bather 200 can transfer onto the cushion 50 on the surface of the platform 20 unencumbered by the lip of the bathtub. In the illustrated embodiment, two of the feet 35 of the bathing seat 10 are positioned on the non-bathing surface floor 80 adjacent the bathtub and these two feet 35 provide substantial support for any weight put onto the transfer pommel 100 and the cushion 50 on the surface of the platform 20 in the transfer area 120.

FIG. 10 is a perspective view diagrams illustrating an example angled handle 110 of a portable bathing seat 10 according to an embodiment of the invention. In the illustrated embodiment, the handle 110 is positioned along a side of the portable bathing seat 10 and adjacent a side portion of the cushion 50. An optional ballast reservoir fill hole 151 and corresponding ballast reservoir fill hole plug 152 are positioned near the handle 110.

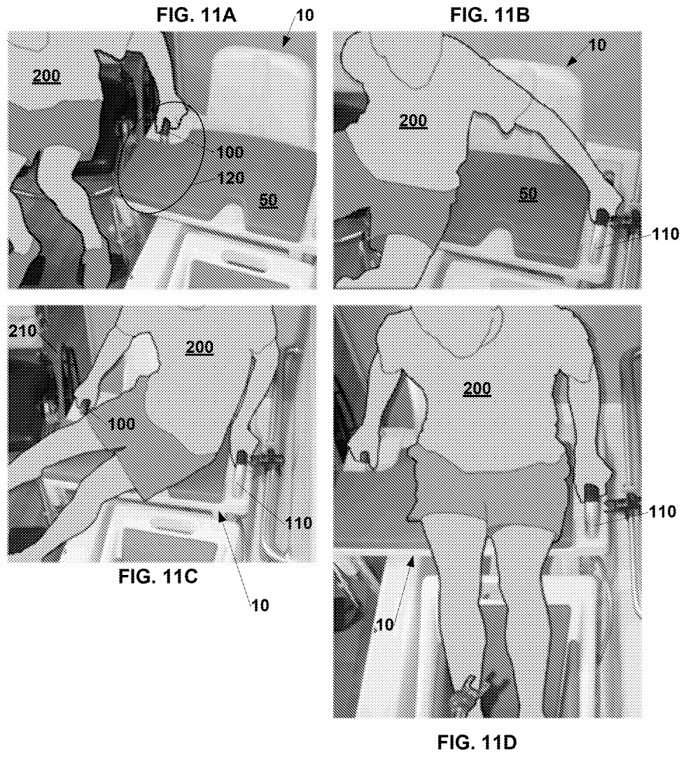

FIGS. 11A-11D are perspective view diagrams illustrating an example bather 200 transferring from a wheelchair 210 onto the portable bathing seat 10 according to an embodiment of the invention. In the illustrated embodiment, the portable bathing seat 10 is positioned with two of four feet on the bathing surface of a bathtub and with two of four feet on the floor surface 80 adjacent to the bathtub. The legs 30 of the portable bathing seat 10 are adjusted so that each foot 35 engages the bathing surface 40 or the floor surface 80 to position the platform 20 in a level orientation. Moreover, the portable bathing seat 10 is positioned such that the transfer area 120 is substantially level to the height of the seating surface of the wheelchair 210 to facilitate a simple transfer of the bather 200 from the wheelchair 210 to the portable bathing seat 10. The transfer pommel 100 is advantageously positioned to allow the bather 200 to grasp the transfer pommel 100 while the bather 200 is still in the wheelchair 210. Additionally, the surface of the transfer area 120 extends over the outer edge 70 of the bathtub to allow the bather 200 to slide directly onto the surface of the transfer area 120 from the wheelchair 210. Once the bather 200 is initially positioned on the surface of the transfer area 120, the bather 200 can reach out and grasp the handle 110 with a first hand and reach out and simultaneously grasp the transfer pommel 100 with a second hand and slide onto the main bathing surface of portable bathing platform 10, which is substantially directly above the bathing surface 40.

### Example Embodiments

In one embodiment, a portable bathing seat includes a platform having a top surface and a bottom surface, a first long side, a second long side, a first short side and a second short side. The portable bathing seat also includes at least two legs. Each leg has one or more feet. At least a portion of the one or more feet of each leg is configured to engage a bathing surface or a non-bathing surface. The at least two legs engage a bottom side of the platform to secure the platform above the bathing surface and/or the non-bathing surface. The platform includes a transfer area proximal the first short side, wherein one or more of the legs secure a surface of the transfer area above the bathing surface and/or the non-bathing surface at a wheelchair transfer height. The bathing seat also includes a transfer pommel secured to the platform proximal the first short side and a handle secured to the platform proximal the second short side. The bathing seat also includes a ballast reservoir secured to the bathing seat below the platform. The ballast reservoir comprises a housing defining a reservoir configured to hold a ballast for providing stability to the portable bathing seat.

In this embodiment, the portable bathing seat also includes a cushion positioned on the top surface of the platform. In this embodiment, the portable bathing seat also includes a backrest extending upward from the first long side. The backrest advantageously includes a vertical trough configured to channel fluid toward the top surface of the platform. Additionally, the platform comprises a through hole proximal the vertical trough, the through hole configured to drain fluid away from the top surface of the platform.

In this embodiment, at least a portion of the transfer area extends beyond an outer edge of a bathtub when the portable bathing seat is positioned with one or more feet on a surface of the bathtub and one or more feet on a floor surface adjacent the bathtub. Additionally, at least a portion of the transfer pommel is positioned beyond the outer edge of the bathtub when the portable bathing seat is positioned with one or more feet on a surface of the bathtub and one or more feet on a floor surface adjacent the bathtub.

In this embodiment, the transfer pommel comprises a generally U shape having a first end and a second end and a middle section and the middle section is parallel to the top surface of the platform when the transfer pommel is secured to the platform. Additionally, the handle comprises a generally U shape having a first end and a second end and a middle section and the middle section is positioned at an angle with respect to the top surface of the platform when the handle is secured to the platform.

In this embodiment, the angle of the middle section may range from 5% to 10%. In this embodiment, the housing of the ballast reservoir comprises one or more kiss-off structures extending from an exterior surface of the housing into the reservoir. The kiss-off structures are configured to provide additional stability to the portable bathing seat. In this embodiment, the ballast used to stabilize the portable bathing seat is a liquid.

In this embodiment, the platform of the portable bathing seat also includes a depression extending from the second long surface toward an interior portion of the platform, the depression is configured to drain fluid away from the top surface of the platform. In this embodiment, the portable bathing seat also includes a cushion positioned on the top surface of the platform, wherein the cushion comprises a recess to expose the depression. In this embodiment, the cushion of the portable bathing seat is made of a foam material. In this embodiment, the platform and the ballast reservoir of the portable bathing seat are formed by a single piece of molded plastic. In this embodiment, at least a portion of the at least two legs are configured to extend and contract in length and are made from aluminum. In this embodiment, the backrest extends upward from the first long side at an angle greater than 90 degrees with respect to the top surface of the platform. Also in this embodiment, the reservoir comprises a drain hole extending through a lower surface of the reservoir housing and the reservoir further comprises a plug configured to seal the drain hole.

Those of skill in the art will appreciate that the various illustrative blocks, features and elements described in connection with the figures and the embodiments disclosed herein can often be implemented using alternative materials and alternative shapes that carry out the same functions described herein. To clearly illustrate this interchangeability, various illustrative components, blocks, features, and steps have been described above generally in terms of their functionality. Whether such functionality is implemented precisely as described above depends upon the particular application and design constraints imposed on the overall system. Skilled persons can implement the described functionality in varying ways for each particular application, but such implementation decisions should not be interpreted as a departure from the scope of the invention. In addition, the grouping of functions within a particular module, block, or step is for ease of description. Specific functions or steps can be moved from one module, block or step to another without departing from the scope of the invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A portable bathing seat comprising:
a platform having a top surface and a bottom surface, a first long side, a second long side, a first short side and a second short side;
at least two legs, each having one or more feet, wherein at least a portion of the one or more feet are configured to engage a bathing surface and the at least two legs further engage the platform to secure the platform above the bathing surface;
the platform having a transfer area proximal the first short side, wherein the legs secure a surface of the transfer area above the bathing surface at a wheelchair transfer height;
a transfer pommel secured to the platform proximal the first short side;
a handle secured to the platform proximal the second short side; and
a ballast reservoir secured to the bathing seat below the platform, the ballast reservoir comprising a housing defining a reservoir configured to hold a ballast for providing stability to the portable bathing seat.

2. The portable bathing seat of the claim 1, further comprising a cushion positioned on the top surface of the platform.

3. The portable bathing seat of claim 1, further comprising a backrest extending upward from the first long side.

4. The portable bathing seat of claim 3, wherein the backrest comprises a vertical trough configured to channel fluid toward the top surface of the platform.

5. The portable bathing seat of claim 4, wherein the platform comprises a through hole proximal the vertical trough, the through hole configured to drain fluid away from the top surface of the platform.

6. The portable bathing seat of claim 1, wherein at least a portion of the transfer area extends beyond an outer edge of a bathtub when the portable bathing seat is positioned with one or more feet on a surface of the bathtub and one or more feet on a floor surface adjacent the bathtub.

7. The portable bathing seat of claim 1, wherein at least a portion of the transfer pommel is positioned beyond an outer edge of a bathtub when the portable bathing seat is positioned with one or more feet on a surface of the bathtub and one or more feet on a floor surface adjacent the bathtub.

8. The portable bathing seat of claim 7, wherein the transfer pommel comprises a U shape having a first end and a second end and a middle section and the middle section is parallel to the top surface of the platform when the transfer pommel is secured to the platform.

9. The portable bathing seat of claim 1, wherein the handle comprises a U shape having a first end and a second end and a middle section and the middle section is positioned at an angle with respect to the top surface of the platform when the handle is secured to the platform.

10. The portable bathing seat of claim 1, wherein the angle of the middle section is 5% to 10%.

11. The portable bathing seat of claim 1, wherein the housing of the ballast reservoir comprises one or more kiss-off structures extending from an exterior surface of the housing into the reservoir.

12. The portable bathing seat of claim 1, wherein the ballast is a liquid.

13. The portable bathing seat of claim 1, wherein the platform further comprises a depression extending from the second long surface toward an interior portion of the platform, the depression configured to drain fluid away from the top surface of the platform.

14. The portable bathing seat of claim 13, further comprising a cushion positioned on the top surface of the platform, wherein the cushion comprises a recess to expose the depression.

15. The portable bathing seat of claim 1, wherein the platform and the ballast reservoir comprise a single piece of molded plastic.

16. The portable bathing seat of claim 1, wherein at least a portion of the at least two legs are configured to extend and contract in length.

17. The portable bathing seat of claim 1, wherein the at least two legs are aluminum.

18. The portable bathing seat of claim 2, wherein the cushion is made of a foam material.

19. The portable bathing seat of claim 3, wherein the backrest extends upward from the first long side at an angle greater than 90 degrees with respect to the top surface of the platform.

20. The portable bathing seat of claim 1, wherein the reservoir comprises a drain hole extending through a lower surface of the housing and the reservoir further comprises a plug configured to seal the drain hole.
